(19) United States
(12) Patent Application Publication
(10) Pub. No.: US 2005/0115762 A1
(43) Pub. Date: Jun. 2, 2005

(54) Speaker Unit

(75) Inventor: Masanori Ito, Tendo-shi (JP)

Correspondence Address: LADAS & PARRY, Suite #2100, 5670 Wilshre Boulevard, Lose Angeles, CA, 90036-5679, US

(73) Assignees: PIONEER CORPORATION; TOHOKU PIONEER CORPORATION

(21) Appl. No.: 10/996,211

(22) Filed: Nov. 22, 2004

(30) Foreign Application Priority Data
Nov. 28, 2003 (JP) P2003-399567

(51) Int. Cl. H04R 7/00; G10K 13/00

(52) U.S. Cl. 181/166

(57) ABSTRACT

The speaker unit comprises a frame which supports the diaphragm and which has holes for passing sound emitted from a rear side of the diaphragm; and a sound guide portion which guides the sound passing through the holes at an angle different from the vibrating direction of the diaphragm to the outside. The sound guide portion has an equalizer to form a horn in which the cross-sectional area of a sound guide space gradually increases along a traveling direction of sound and guides the sound passing through the holes 16 at an angle different from the vibrating direction of the diaphragm to the outside.

### BACKGROUND OF THE INVENTION

1. Field of the Invention

The present invention relates to a technical field of a speaker unit.

2. Related Art

In recent years, with the miniaturization of mobile phones and personal digital assistants (PDAs), there have been strong demands for flat speaker units to be mounted therein. In addition, there have been demands for these apparatuses to realize good sound quality.

Conventionally, speakers using piezoelectric elements that are adopted in these apparatuses to satisfy the miniaturization are suitable for generating sounds not requiring for high sound quality, such as beep sounds (signal sounds)., but are not suitable for reproducing sounds requiring for high sound quality, such as music and voice. Therefore, horn-type speakers having a large size are adopted in these apparatuses to reproduce sounds requiring for high sound quality at the sacrifice of the demand for miniaturization.

However, in these conventional speakers, a speaker surface must be arranged on an outer surface of the apparatus, which restricts the design of apparatuses and throws obstacles to the demand for miniaturization.

Meanwhile, Japanese Patent Application Laid-Open Publication No. 2001-324982 (FIG. 1) discloses, for example, that a technique of guiding a sound emitted from a front surface of a speaker in a direction different from a vibrating surface of the speaker.

Further, Japanese Patent Application Laid-Open Publication No. H10-84192 (FIG. 1) also discloses, for example, that a technique of simultaneously emitting a sound from one speaker in two directions, that is, in the front and rear directions thereof.

However, according to the above-described first conventional technique disclosed, a resonance cover is provided in the front of a speaker (the side of the vibrating surface). The output of sound is improved in an air chamber formed by a diaphragm and the resonance cover, and the sound is then emitted from a cutout portion provided in a wall portion. However, in this case, the thickness of the speaker increases by the thickness of the air chamber and the resonance cover, which does not meet the demand for a small-sized and flat speaker.

According to the above-described second conventional technique, the sound emitted from the front surface of the diaphragm is emitted to the outside through openings provided in the front of a speaker and openings provided in the side of the speaker. However, it is not disclosed to use the sound emitted from the rear surface of the diaphragm.

### SUMMARY OF THE INVENTION

Accordingly, the present invention is designed to solve the above-mentioned problems, and it is an object of the present invention to provide a small-sized and flat speaker unit capable of emitting a sound at an angle different from the vibrating direction of a speaker.

The present invention will be described below. Although reference numerals in the accompanying drawings will be accessorily written as parenthetic numerals for descriptive convenience, the present invention is not limited to the illustrated features.

The above object of the present invention can be achieved by a speaker unit (1) provided with: a frame (15) which supports a diaphragm (22) and has holes (16) for passing sound emitted toward the side of rear surface of the diaphragm (22); and a sound guide portion (3) which guides the sound passing through the holes (16) at an angle different from a vibrating direction of the diaphragm (22) to emit the sound to the outside.

### BRIEF DESCRIPTION OF THE DRAWINGS

FIG. 1 shows an exploded view of a speaker unit according to an embodiment of the present invention;

FIG. 2 shows a half cross-sectional view illustrating the speaker unit according to the embodiment of the present invention; and

FIG. 3 shows a plan view of a sound guide portion according to the embodiment of the present invention.

### DESCRIPTION OF THE PREFERRED EMBODIMENTS

Next, as an embodiment of a speaker unit according to the present invention, for example, a speaker unit for a mobile phone will now be described with reference to the accompanying drawings.

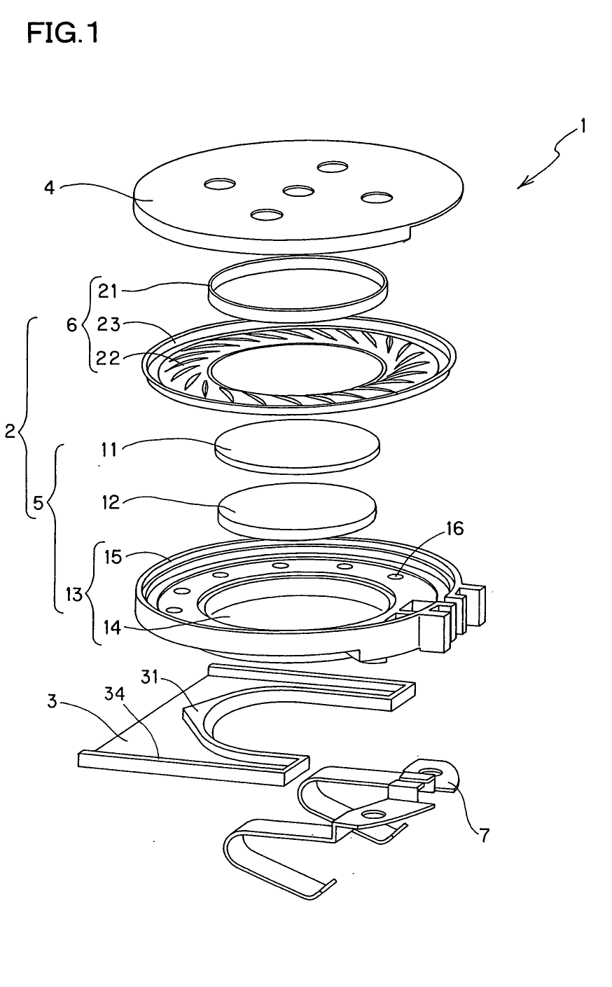

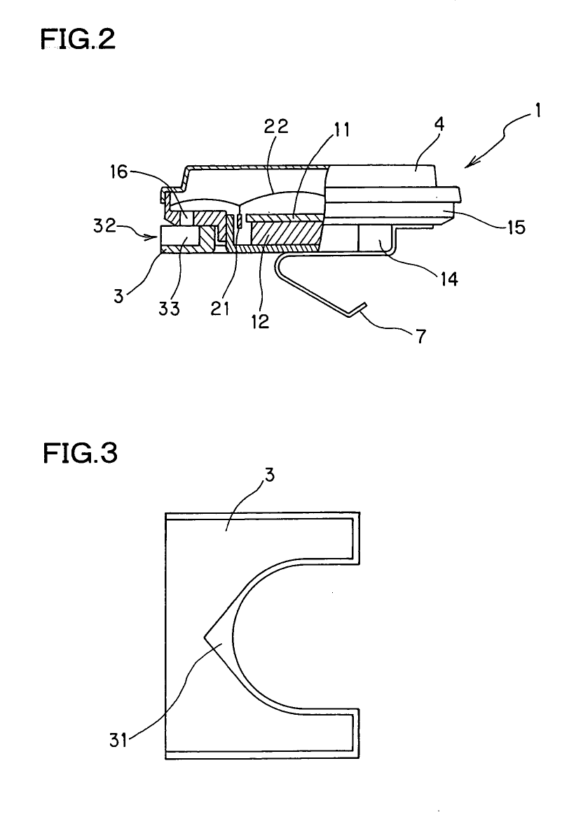

FIG. 1 shows an exploded view of a speaker unit according to the embodiment of the present invention, and FIG. 2 shows a half cross-sectional view of the speaker unit according to the embodiment of the present invention.

A speaker unit 1 comprises an inner magnet type speaker 2 and a sound guide portion 3, and a case cap 4 provided in the front thereof. The speaker 2 has a magnetic circuit 5 and a vibrating portion 6, and a terminal shank 7 for position fixing is provided on a rear side of the speaker 2.

The magnetic circuit 5 comprises a plate 11, a magnet 12, and a body 13 composed of a yoke 14 and a frame 15.

The plate 11 is made of a magnetic material, for example, pure iron etc., and has a disc shape whose outer diameter is substantially equal to that of the magnet 12. The plate 11 is fixed to the magnet 12.

The magnet 12 has a disc shape magnetized with a ferromagnetic material, for example, ferrite etc., and is attached to the body 13. In the inner magnet type speaker 2, an alnico magnet is suited for the magnet 12.

The body 13 comprises the yoke 14 and the frame 15 provided around the yoke 14.

The yoke 14 is made of a magnetic material, for example, pure iron etc., and has substantially a bowl shape in which a central bottom surface has a flat portion. The magnet 12 is fixed to the central bottom surface of the yoke 14 to prevent the magnetic flux supplied therefrom from leaking to the outside.

The frame 15 is made of, for example, plastics and has a hollow disc shape having the yoke 14 at a central hole portion. In addition, an outer circumferential portion (edge 23) of a diaphragm 22 is fixed to and supported by a skirt portion provided in the outer circumference of the frame 15. Further, the frame 15 has a plurality of holes 16 at portions being in contact with the side of a rear surface of the diaphragm 22 to reduce the distortion of sound caused by the sound pressure of the rear surface of the diaphragm 22.

A vibrating portion 6 is arranged in the front of the magnetic circuit 5 and has a voice coil 21 and the diaphragm 22.

The voice coil 21 is composed of a conducting wire for a voice coil, such as copper wire, aluminum wire, or copper clad aluminum wire and is wound on a coil bobbin (not shown) attached to the diaphragm 22 by a round wire two-layer winding or an edgewise winding. The voice coil 21 is arranged so as not to bring into contact with a magnetic gap formed between an outer circumferential surface of the plate 11 and an inner circumferential surface of the yoke 14.

The diaphragm 22 is made of a material having high Young's modulus, such as natural fibers, synthetic fibers, plastics, metals, etc. and is arranged to have a funnel-shaped paracurved cone. In addition, the voice coil 21 is fixed to a central portion of the diaphragm 22. The diaphragm 22 has the edge 23 at its outer circumference and is attached to the frame 15.

The edge 23 is made of a material having good compliance and strong mechanical fatigue strength, such as resin impregnated cloth or rubber or the like. In addition, the edge 23 has functions to reinforce the circumference of the diaphragm 22 and is supported by the frame 15. Further, the edge 23 blocks off the flow of air through the diaphragm 22.

The sound guide portion 3 is closely adhered to the rear surface of the inner magnet type speaker 2.

Here, the shape of the sound guide portion 3 will be described with reference to FIG. 3. FIG. 3 shows a plan view illustrating only the sound guide portion 3.

The sound guide portion 3 is made of synthetic resin, for example, plastics etc. The sound guide portion 3 is a square-shaped plate whose one side has substantially the same length as an outer diameter of the frame 15 and whose one side is retreated from the terminal shank 7 provided toward the side of the rear surface of the speaker unit 1 and the outer diameter of the yoke 14. In addition, a skirt portion 34 is formed in the outer circumferential portion of the sound guide portion 3 excluding the portion of a slit 32, which will be described later.

The sound guide portion 3 diverts an outer wall of the yoke 14 such that the skirt portion 34 formed in the outer circumferential portion excluding the slit 32 is closely adhered to the frame 15 to prevent sound leakage. In addition, a sound guide space 33 is formed between the sound guide portion 3 and the frame 15. As an outlet for sound of the sound guide space 33, the sound guide portion 3 and the frame 15 form the slit 32 at a position opposite to the side where the terminal shank 7 is arranged. Therefore, the sound emitted from the holes 16 of the frame 15 is emitted from the sound guide space 33 to the outside through the slit 32.

Further, the sound guide portion 3 has an equalizer (phase equalizer) 31 at the middle of the sound guide space 33 between the frame 15 and the slit 32. In the sound guide portion 3, the cross-sectional area of the sound guide space 33 gradually increases along the traveling direction of sound to form a horn.

Here, for example, the speaker unit 1 according to the present embodiment constitutes an example of the speaker unit oft the present invention; the sound guide portion 3 constitutes an example of the sound guide portion of the present invention; the frame 15 constitutes an example of the frame of the present invention; the holes 16 constitute an example of the holes of the present invention; the diaphragm 22 constitutes an example of the diaphragm of the present invention; the edge 23 constitutes an example of the outer circumferential portion of the present invention; and the sound guide space 33 constitutes an example of the sound guide space of the present invention.

A phenomenon when the speaker unit 1 having the above-mentioned structure generates sound will be described below.

When the diaphragm 22 vibrates by the operation of the magnetic circuit 5 and the vibrating portion 6 after receiving an audio signal, a sound is emitted toward the front of the speaker unit 1 through holes provided in the case cap 4. At the same time, the sound is propagated toward the rear side of the diaphragm 22 through the holes 16 of the frame 15. In other words, the sound is emitted to the sound guiding space 33 through the holes 16. Then, the sound which enters into the sound guiding space 33 changes its traveling direction by hitting against the wall of the sound guide portion 3 and proceeds toward the slit 32, and then is emitted from the slit 32 to the outside.

Since the sound guiding space 33 from the holes 16 to the slit 32 constitutes the horn whose cross-sectional area gradually increases, emission resistance increases therein. Therefore, high efficiency becomes available, even when the amplitude of the diaphragm 22 is small, thereby a sufficient sound volume is obtained.

The above-described embodiment has the following effects:

The speaker unit 1 according to the present invention comprises the frame 15 which has the holes 16 provided on the side of the rear surface of the diaphragm 22 and which supports the edge 23 of the diaphragm 22 and the sound guide portion 3 for guiding the sound emitted from the holes 16. In the speaker unit 1, the sound guide portion 3 guides the sound emitted from the holes 16 at an angle different from the vibrating direction of the diaphragm 22. Therefore, since the sound generated from the rear surface of the diaphragm, which used to be noise in the conventional art, is emitted to the outside through the sound guide portion, it is possible to use both the sound emitted from the front surface of the diaphragm and the sound from the rear surface of the diaphragm, thereby effectively utilizing the energy of sound. Thus, in small-sized apparatuses, such as mobile phones, it is possible to obtain high output using only a small-sized speaker when a high-output speaker is not equipped.

The holes 16 according to the present embodiment have functions to reduce the distortion of sound caused by the sound pressure of the rear surface of the diaphragm 22. Therefore, the holes 16 are used to reduce the distortion of sound caused by the sound pressure of the rear surface of the diaphragm 22 which used to be present in the conventional art, and the sound from the rear surface of the diaphragm is emitted to the outside through the sound guide portion. Thus, according to the present invention, it is possible to supply high sound quality without the distortion of sound.

The sound guide portion 3 according to the present embodiment forms a horn in which the cross-sectional area of the sound guide space 33 gradually increases along the traveling direction of sound. In this way, high emission resistance can be obtained, and thus it is possible to obtain high efficiency even when the amplitude of the diaphragm 22 is small, thereby obtaining a sufficient sound volume.

The equalizer 31 is provided in the sound guide portion 3 according to the present embodiment. Therefore, it is possible to gradually increase the cross-sectional area of the sound guide space 33 along the traveling direction of sound by manipulating the shape of the equalizer 31. Thus, the structure of the sound guide portion 3 can be simplified.

The sound guide portion 3 according to the present embodiment guides the sound emitted from the holes 16 at an angle perpendicular to the vibrating direction of the diaphragm 22. Therefore, since the sound from the rear surface of the diaphragm, which used to be noise in the conventional art, is emitted to the outside through the sound guide portion, it is possible to use both the sound emitted from the front surface of the diaphragm and the sound from the rear surface of the diaphragm, thereby effectively utilizing the energy of sound. In small-sized apparatuses, such as mobile phones, it is possible to obtain high output using only a small-sized speaker when a high power speaker is not equipped.

Further, the present embodiment is not limited to the above-mentioned embodiment, but can be modified as following examples:

In the above-mentioned embodiment, it has been explained that the sound guide portion 3 and the frame 15 are separately formed from each other. However, the sound guide portion 3 and the frame 15 may be integrated into one body. When an integrated body is made by molding synthetic resin, it is possible to easily manufacture the integrated body with a mold using a slide. As a result, the number of components can be reduced, and thus the maintenance cost of the components and the manufacturing cost of a product can be reduced.

In the above-mentioned embodiment, it has been explained that the slit 32 is formed in one direction in order to provide the sound guide space 33 so as to avoid the terminal shank 7 arranged at one side of the rear surface of the speaker unit 1. However, it may be formed in two directions if space is allowed. In this case, the two slits may be formed at different angles. When the slits are provided in a plurality of directions, it is possible to emit sound in the plurality of directions.

In the above-mentioned embodiment, it has been explained that the holes are used to reduce the variation of the sound pressure in the space of the rear surface of the diaphragm 22, but the present invention is not limited thereto. Even when the variation of the sound pressure in the rear space of the diaphragm does not matter, it is possible to utilize the present invention by providing the holes in the frame to emit the sound from the rear surface.

In the above-mentioned embodiment, it has been explained that an equalizer is provided in the sound guide space 33, but the present invention is not limited thereto. Even when the equalizer is not provided therein, it is possible to gradually increase the cross-sectional area of the sound guide space by manipulating the shape of the sound guide portion.

In the above-mentioned embodiment, it has been explained that a horn is formed such that the cross-sectional area of the sound guide space 33 from the holes 16 to the slit 32 gradually increases without changing the thickness of the sound guide portion 3, but the present invention is not limited thereto. As far as the arrangement space of the speaker unit is permitted, it is possible to gradually increase the cross-sectional area of the sound guide space by changing the thickness (height) of the sound guide portion.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-399567 filed on Nov. 28, 2003 including the specification, claims, drawings and summary is incorporated herein by reference in its entirety.

1. A speaker unit comprising:
a frame which supports a diaphragm and has holes for passing sound emitted toward the side of rear surface of the diaphragm; and
a sound guide portion which guides the sound passing through the holes at an angle different from a vibrating direction of the diaphragm to emit the sound to the outside.

2. The speaker unit according to claim 1,
wherein the holes reduce the distortion of sound caused by sound pressure of the rear surface of the diaphragm.

3. The speaker unit according to claim 1,
wherein the sound guide portion forms a horn whose cross-sectional area gradually increases.

4. The speaker unit according to claim 2,
wherein the sound guide portion forms a horn whose cross-sectional area gradually increases.

5. The speaker unit according to claim 3,
wherein the sound guide portion has an equalizer.

6. The speaker unit according to claim 4,
wherein the sound guide portion has an equalizer.

7. The speaker unit according to claim 1,
wherein the sound guide portion guides the sound emitted from the holes in a direction perpendicular to the vibrating direction of the diaphragm.

8. The speaker unit according to claim 2,
wherein the sound guide portion guides the sound emitted from the holes in a direction perpendicular to the vibrating direction of the diaphragm.

9. The speaker unit according to claim 3,
wherein the sound guide portion guides the sound emitted from the holes in a direction perpendicular to the vibrating direction of the diaphragm.

10. The speaker unit according to claim 4,
wherein the sound guide portion guides the sound emitted from the holes in a direction perpendicular to the vibrating direction of the diaphragm.

11. The speaker unit according to claim 5,
wherein the sound guide portion guides the sound emitted from the holes in a direction perpendicular to the vibrating direction of the diaphragm.

12. The speaker unit according to claim 6,
wherein the sound guide portion guides the sound emitted from the holes in a direction perpendicular to the vibrating direction of the diaphragm.
